(19) United States
(12) Patent Application Publication
(10) Pub. No.: US 2016/0245445 A1
(43) Pub. Date: Aug. 25, 2016

(54) Dual-Wall Fitting for Fluid Communication

(71) Applicant: Caterpillar Inc., Peoria, IL (US)

(72) Inventors: Jack Merchant, West Lafayette, IN (US); Nicholas Wainscott, Rossville, IN (US)

(73) Assignee: Caterpillar Inc., Peoria, IL (US)

(21) Appl. No.: 14/630,032

(22) Filed: Feb. 24, 2015

(51) Int. Cl. F16L 39/00; F16L 21/00

(52) U.S. Cl. CPC F16L 39/00; F16L 21/00

(57) ABSTRACT

A dual-wall fitting includes an outer fitting member and a fitting insert. The fitting insert may be slideably placed within the outer fitting member. The outer fitting member has an inner surface and a channel surface. The inner surface defines an upper channel and the channel surface defines a first leakage channel that extends from an exterior of the outer fitting member to the upper channel. The fitting insert has an outer insert surface that defines a groove. When the fitting insert is slideably placed within the outer fitting member, the inner surface of the outer fitting member and the groove defined by the fitting insert define a second leakage channel. The first leakage channel is in fluid communication with the second leakage channel.

### TECHNICAL FIELD

This disclosure relates generally to a fluid transfer fitting, and more particularly, to a system and apparatus for a dual-walled fluid transfer fitting for conveying fluid from one system to another.

### BACKGROUND

Fluid transfer fittings may be used to fluidly couple one or more fluid transfer conduits together. Fluid transfer fittings may also be used to adapt different sizes or shapes of fluid transfer conduits, or for other purposes, such as regulating or measuring fluid flow. A fluid transfer conduit may include a straight, curved, or angled section of pipe or tube capable of conveying a fluid. During the flow of a fluid through the fitting, leakage may occur resulting in a loss of efficiency, damage to neighboring components, contamination, or other unintended consequences. Tolerance of fluid leakage from a fluid transfer fitting may vary with the fluid pressure within the fitting and the composition of the fluid.

Current systems for reducing leakage in a fitting include the use of dual-wall fittings, which may define multiple passages. U.S. Pat. No. 5,186,502 describes a double-containment pipe fitting having an outer containment housing and an inner carrier housing. The carrier housing is positioned within the containment housing and securely connected to the containment housing by a plurality of restraining means. An annulus is defined between the carrier and containment housings. During operation, as fluids leak from the inner carrier housing, the annulus can facilitate the drainage of the leaked fluid. Although this conventional system may provide an approach to handle leakage, it includes multiple parts, can be expensive to replace, and can be complex to construct.

Thus, an improved and/or simplified fluid transfer fitting for coupling fluid transfer lines together is desired to manage leakage and to increase the effectiveness of the fitting.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

An aspect of the present disclosure provides a fitting assembly that includes an outer fitting member and a fitting insert. The outer fitting has an outer body which includes an outer fitting surface, a first inner surface, a second inner surface, and a third inner surface. The first inner surface defines a first channel and the second inner surface defines a second channel. The second channel aligns with the first channel in a longitudinal direction and extends from the outer fitting surface to the first channel. The first channel extends from the second channel to the outer fitting surface. The third inner surface defines a first leakage channel that extends to the outer fitting surface. The fitting insert has an upper body portion and a lower body portion. The upper body portion is slideably disposed within the first channel and the lower body portion is slideably disposed within the second channel. The upper body portion includes an outer insert surface in slideable contact with the first inner surface. The outer insert surface defines a groove, such that a second leakage channel is formed between the outer insert surface and the first inner surface within the groove. The second leakage channel extends to the outer fitting surface. The first leakage channel and the second leakage channel are in fluid communication.

Another aspect of the present disclosure provides a fitting system for an engine. The fitting system includes a cylinder head, an outer fitting member, and a fitting insert. The outer fitting member is coupled to the cylinder head. The outer fitting has an outer body which includes an outer fitting surface, a first inner surface, a second inner surface, and a third inner surface. The first inner surface defines a first channel and the second inner surface defines a second channel. The second channel aligns with the first channel in a longitudinal direction and extends from the outer fitting surface to the first channel. The first channel extends from the second channel to the outer fitting surface. The third inner surface defines a first leakage channel that extends to the outer fitting surface. The fitting insert has an upper body portion and a lower body portion. The upper body portion is slideably disposed within the first channel and the lower body portion is slideably disposed within the second channel. The upper body portion includes an outer insert surface in slideable contact with the first inner surface. The outer insert surface defines a groove, such that a second leakage channel is formed between the outer insert surface and the first inner surface within the groove. The second leakage channel extends to the outer fitting surface. The first leakage channel and the second leakage channel are in fluid communication.

Another aspect of the present disclosure provides a fitting body. The fitting body including a first outer fitting surface, a second outer fitting surface, a first inner surface, a second inner surface, and a third inner surface. The second outer fitting surface opposes the first outer fitting surface in a longitudinal direction. The first inner surface defines a first channel. The second inner surface defines a second channel that aligns with the first channel in the longitudinal direction. The second channel extends from the second outer fitting surface to the first channel, and the first channel extends from the second channel to the first outer fitting surface. The third inner surface defines a first leakage channel that extends from the second outer fitting surface to the first channel.

### BRIEF DESCRIPTION OF THE DRAWINGS

FIG. 1 illustrates a schematic view of a fuel injection system, according to an aspect of this disclosure.

FIG. 2 illustrates a cross sectional view of a fitting assembly, according to an aspect of this disclosure.

FIG. 3 illustrates a cross sectional side view of an outer fitting member, according to an aspect of this disclosure.

FIG. 4 illustrates a cross sectional side view of a fitting insert, according to an aspect of this disclosure.

FIG. 5 illustrates a top view of a fitting assembly, according to an aspect of this disclosure.

FIG. 6 illustrates a cross sectional view of a section of a dual-wall hose, according to an aspect of this disclosure.

FIG. 7 illustrates a cross sectional view of a fitting assembly coupled to a cylinder head, according to an aspect of this disclosure.

### DETAILED DESCRIPTION

The disclosure relates generally to dual-walled fittings used for fluid couplings, such as a fitting for a gaseous fuel injection system. For example, in maritime operations involving dual-walled gaseous fuel passages, a dual-walled fitting may be coupled to a cylinder head on one end and be configured to couple to a gaseous fuel delivery tube on another end. The dual-walled fitting may form an outer channel and an inner channel, whereby the outer channel may be capable of receiving gaseous fuel that may leak from the inner channel.

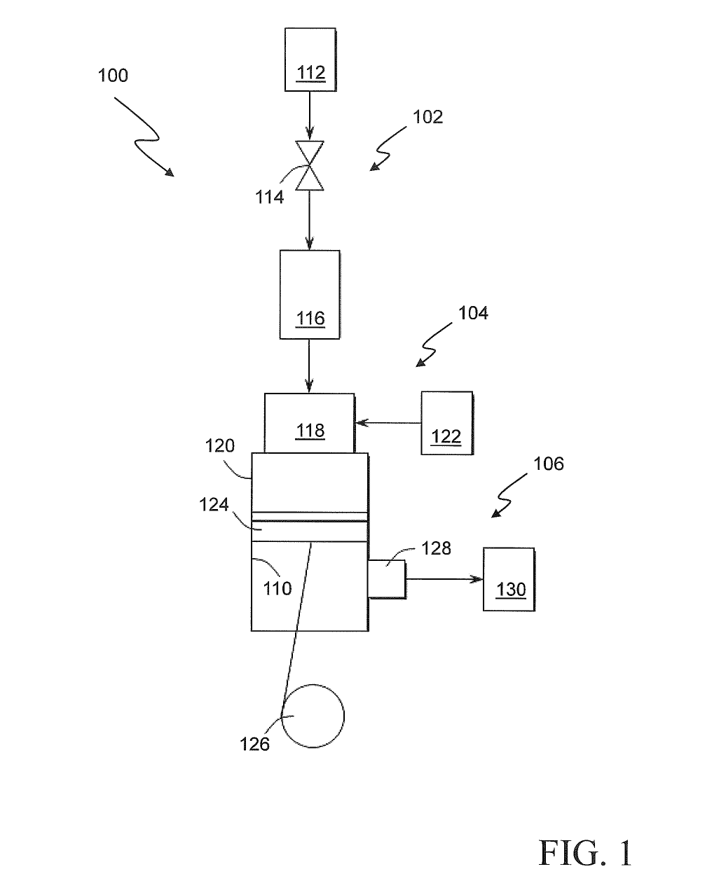

FIG. 1 illustrates a schematic of a gaseous fuel injection system 100, according to one aspect of the disclosure. In this view, the fuel injection system 100 includes a gaseous supply system 102, an air intake system 104, and an exit exhaust system 106. Air and fuel flow through the system 100 into a cylinder 110. After entering the cylinder 110, the fuel may ignite and perform work on a piston 124. After the combustion process, the exhaust gases exit along the exit exhaust system 106.

The gaseous supply system 102 may include a gaseous fuel supply 112, a fuel pressure regulator or valve 114, and a fuel admission valve or injector 116. It will be appreciated that other fuel line components may be used in the gaseous supply system 102, such as a gas rail, a safety valve, sensors, actuators, or the like. The gaseous fuel supply 112 may include a liquefied fuel tank, a cryogenic pump, or other elements known in the art to benefit the operation of a gaseous fuel supply. In an aspect of this disclosure, the fuel supply 112 may include natural gas, such as compressed natural gas or liquefied natural gas; however, other fuel types may be used.

The pressure regulator 114 may receive gaseous fuel from the gaseous fuel supply 112 prior to or upstream of the fuel admission valve 116. The gaseous fuel enters the fuel admission valve 116 under pressure from the fuel supply 112 when the pressure regulator 114 is in an open position. Within the fuel admission valve 116 the fuel may be selectively controlled and timed before entering an intake manifold 118 or being directly injected into a combustion chamber defined by the engine housing 120 and the piston 124. A fuel hose (not shown) may fluidly connect the fuel admission valve 116 and the intake manifold 118 to transport the fuel to the manifold 118. The fuel hose may be a single-wall hose, a dual-wall hose, or other suitable hose known in the art. As used herein, the terms “pipe”, “tube”, “hose”, “conduit”, or the like refer to any apparatus used to transfer a fluid. These terms should not be understood to limit a fluid transfer device to a particular size, shape, composition, or cross-section.

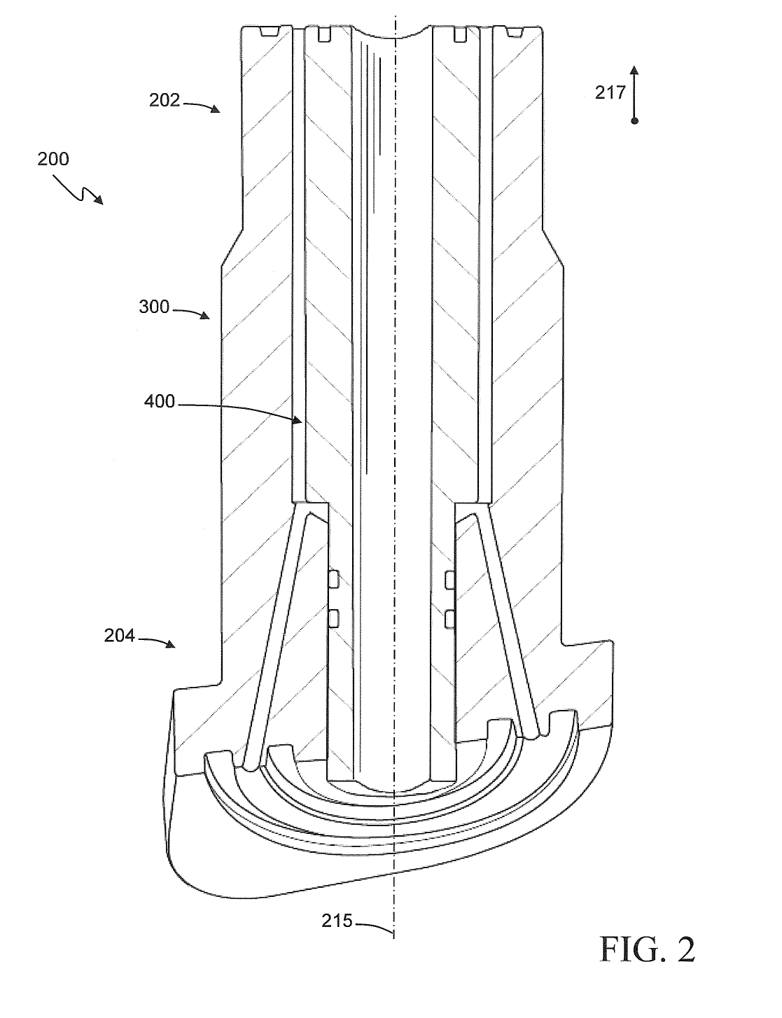

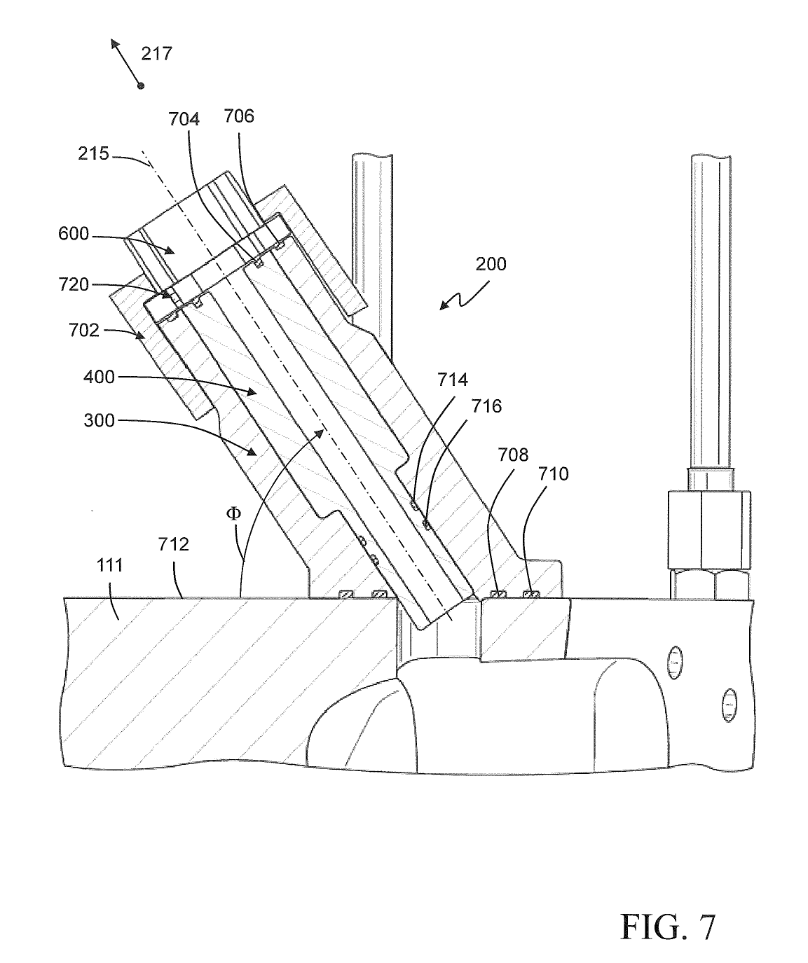

A fitting assembly 200 (shown in FIG. 2) may be coupled to the intake manifold 118 and configured to receive and couple to the fuel hose, thereby securing the fuel hose to the intake manifold 118. The intake manifold 118 may be coupled to an engine housing 120 and configured to supply intake air as well as gaseous fuel to each cylinder 110 by way of appropriate intake valves (not shown). It will be appreciated that the fitting assembly 200 may be coupled directly to a cylinder head 111 (as shown in FIG. 7). In this embodiment, the fuel and air may mix within inlet passages prior to entering the cylinder 110.

Referring still to FIG. 1, the air intake system 104 includes an air inlet 122 for supplying air to the intake manifold 118. Various components known in the art may form part of the air intake line 104 including a compressor, an aftercooler, filters, or the like. In other embodiments, the air intake line 104 may include one or more valves for various purposes including for controlling the intake pressure into the fuel injection system 100. The intake air is combined with the fuel within the intake manifold 118 and provided to the engine cylinder 110 for combustion.

After the air and gaseous fuel mixture flow through their corresponding supply systems, they enter the cylinder 110. The cylinder 110 is located within the engine housing 120 along with a piston 124. The piston 124 is movable within cylinder 110 between a top dead center position and a bottom dead center position in a conventional manner to induce rotation of a crankshaft 126. It will be appreciated that there may be additional cylinders which are not shown in FIG. 1, commonly six, eight, twelve or more cylinders, each having a piston reciprocable therein to contribute to the rotation of the crankshaft 126. During a combustion process, a high cetane number fuel, such as diesel fuel, may be injected into the the mixture of air and gaseous fuel within the cylinder 110 and auto ignite in response to the pressure and temperature within the cylinder 110. In turn, ignition of the high cetane fuel may ignite the gaseous fuel, which may have a relatively lower cetane value, thereby driving the piston 124 and inducing rotation of the crankshaft 126.

After the combustion process, the exhaust created during combustion flows out of the cylinder 110, along the exhaust line 106 from an exhaust manifold 128 to an exhaust outlet 130.

FIG. 2 illustrates a cross sectional view of a fitting assembly 200, according to an aspect of this disclosure. The fitting assembly 200 may include an outer fitting member 300 and a fitting insert 400 positioned within the outer fitting member 300. The fitting assembly 200 may have an upper portion 202 and a lower portion 204 positioned below the upper portion 202 in a longitudinal direction 217 that extends parallel to a central longitudinal axis 215. The fitting insert 400 may be positioned within the outer fitting member 300 along the central axis 215, such that the fitting insert 400 and the outer fitting member 300 are coaxial. The terms “above” and “below,” as used herein, describe the positions of certain components relative to one another and are thus approximations. The terms “above”, “upper”, or “uppermost” mean a position that is closer to the upper portion 202 in the longitudinal direction 217, and the terms “below”, “bottom”, or “bottommost” mean a position closer to the lower portion 204 of the fitting assembly 200 in the longitudinal direction 217.

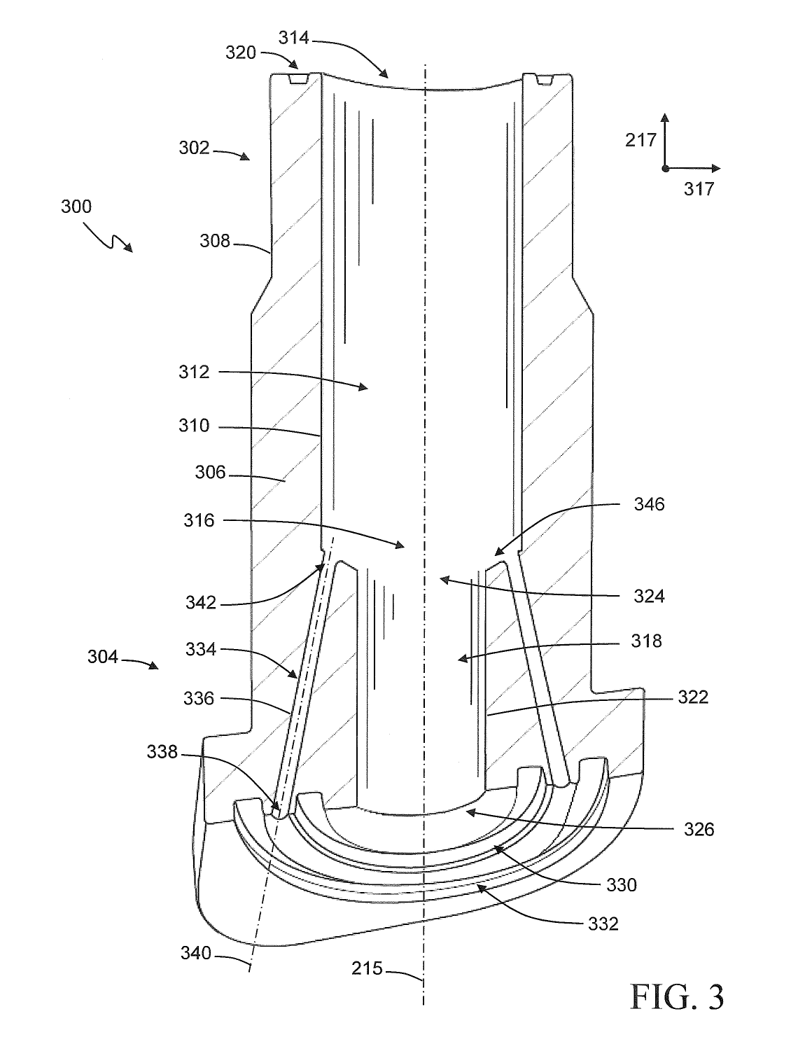

Referring to FIG. 3, the outer fitting member 300 may include an outer body 306 having an upper body portion 302, a lower body portion 304, and an outer body surface 308 extending about the outer body 306. The outer body 306 may be constructed using a material that has a resistance to deformation and that is commonly used in the art, such as cast iron. The upper body portion 302 of the outer body 306 may include an upper inner surface 310 that defines an upper body channel 312. The upper inner surface 310 may extend circumferentially about the central axis 215 and extend longitudinally along the central axis 215.

The upper body channel 312 may include a first upper channel opening 314 at an uppermost end of the channel 312 and a second upper channel opening 316 at a bottommost end of the channel 312. The first upper channel opening 314 may open to the outer body surface 308. The second upper channel opening 316 may open to a lower body channel 318.

In an aspect of this disclosure, the upper inner surface 310 may be parallel to the central axis 215, whereby the first upper channel opening 314 has a substantially similar diameter to the second upper channel opening 316. In an alternate aspect, the upper inner surface 310 may extend outwardly from the bottommost end of the channel 312 to the uppermost end of the channel 312, forming a conical shape about the central axis 215. In this aspect, the first upper channel opening 314 may have a larger diameter than the second upper channel opening 316. Unless specified otherwise, use of the word “substantially” herein is intended to mean considerable in extent or largely but not necessarily wholly that which is specified.

The upper body portion 302 of the outer body 306 may also include a first outer body radial groove 320. The first outer body radial groove 320 may extend circumferentially about the central axis 215 along the uppermost portion of the outer body surface 308. It will be appreciated that a “groove” as used herein may include a variety of shapes, for example, semi-circular, rectangular, triangular, or the like.

The lower body portion 304 of the outer body 306 may include a lower inner surface 322 that defines the lower body channel 318. The lower inner surface 322 may extend circumferentially about the central axis 215 and extend longitudinally along the central axis 215. The lower body channel 318 may include a first lower channel opening 324 at an uppermost end of the lower body channel 318 and a second lower channel opening 326 at a bottommost end of the lower body channel 318. The first lower channel opening 324 may open to the upper body channel 312, such that the lower body channel 318 is in fluid communication with the upper body channel 312. The second lower channel opening 326 may open to the outer body surface 308.

In an aspect of this disclosure, the lower body channel 318 may align with the upper body channel 312 along the central longitudinal axis 215. The alignment of the lower body channel 318 and the upper body channel 312 may form an outer fitting shoulder 346. The outer fitting shoulder 346 may extend circumferentially about the central axis 215. In an aspect of this disclosure, a diameter of the lower body channel 318 may be less than a diameter of the upper body channel 312, thereby forming the outer fitting shoulder 346.

The lower body portion 304 of the outer body 306 may also include a second outer body radial groove 330, a third outer body radial groove 332, and a first leakage channel 334. The first and second outer body radial grooves 330, 332 may extend circumferentially about the central axis 215 along the bottommost portion of the outer body surface 308. The second outer body radial groove 330 and the third outer body radial groove 332 may be spaced radially with respect to one another in a direction 317 that is perpendicular to the central axis 215.

The first leakage channel 334 may be defined by an inner leakage surface 336 that extends from the bottommost end of the lower body portion 304 to an uppermost end of the lower body portion 304 along a channel axis 340. The inner leakage surface 336 may extend circumferentially about the channel axis 340 and define a first leakage channel opening 338 and an opposing second leakage channel opening 342. The first leakage channel opening 338 may open to the outer body surface 308 and positioned in between the second outer body radial groove 330 and the third outer body radial groove 332 in the radial direction 317 that is perpendicular to the central axis 215. The second leakage channel opening 342 may open to the bottommost end of the upper body channel 312; however, it will be appreciated that the second leakage channel opening 342 may open at various locations along the upper body channel 312.

It will be appreciated that multiple first leakage channels 334 may be included in the lower body portion 304 of the body 306. Each first leakage channel 334 may extend from the outer body surface 308 to the upper body channel 312, such that the first channel upper opening 314 is in fluid communication with the first leakage channel opening 338.

The channel axis 340 may be angularly offset from the central longitudinal axis 215. This may be for a variety of reasons, for example, to allow for various size first and second outer body radial grooves 330, 332, to allow for a thicker lower body portion 304, improved manufacturability, or for other reasons. In alternative embodiments, the channel axis 340 may be aligned parallel to the central longitudinal axis 215.

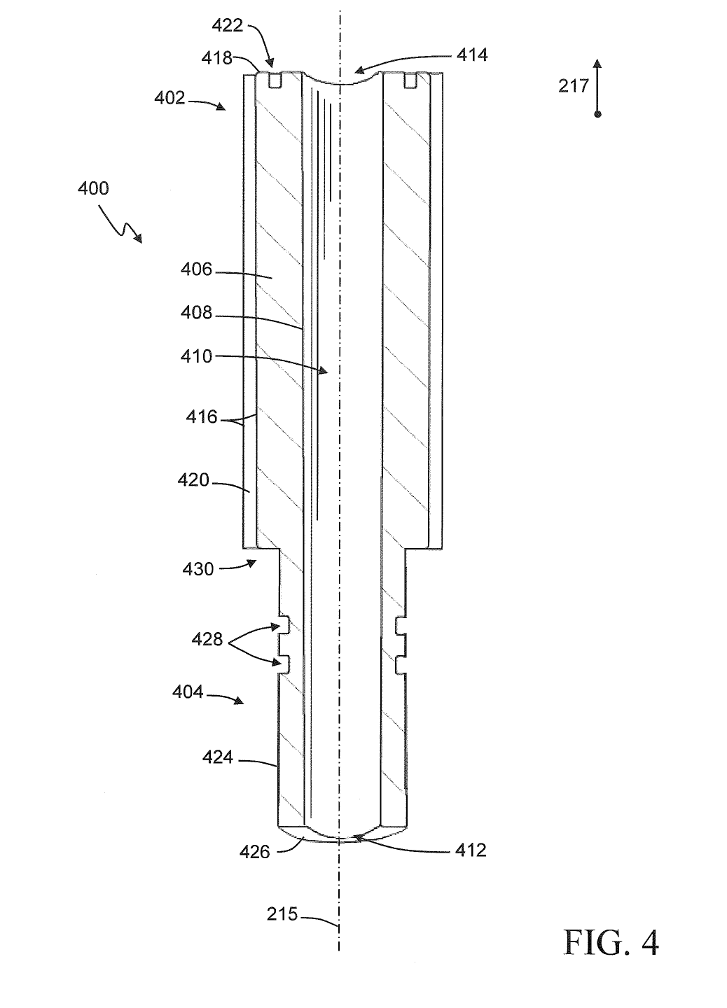

FIG. 4 illustrates a cross sectional side view of the fitting insert 400. The fitting insert 400 may include an insert body 406 having an upper insert portion 402, a lower insert portion 404, and an inner insert surface 408 that defines an inner flow channel 410. The insert body 406 may be constructed using a material that has a high strength, such as stainless steel, aluminum, titanium, or the like. The inner insert surface 408 may extend circumferentially about the central axis 215 and extend in the longitudinal direction 217. The inner insert surface 408 may extend through the insert body 406 and define a first insert opening 412 at the bottommost end of the lower insert portion 404 and a second insert opening 414 at the uppermost end of the upper insert portion 402. The first insert opening 412 may open to a lower insert surface 426 and the second insert opening 414 may open to an upper insert surface 418.

The upper insert portion 402 defines a portion of the inner flow channel 410 and further includes an upper outer insert surface 416 and the upper insert surface 418. The outer insert surface 416 extends from a bottommost end of the upper insert portion 402 to the upper insert surface 418 in the longitudinal direction 217. In an alternative aspect, the outer insert surface 416 may extend outwardly from the bottommost end of the upper insert portion 402 to the uppermost end of the upper insert portion 402, forming a conical shape about the central axis 215. In this aspect, the diameter of inner flow channel 410 may remain substantially the same, while the diameter of the uppermost end of the upper insert portion 402 may be larger than the diameter of the bottommost end of the upper insert portion 402.

The outer insert surface 416 may define an axial groove 420. The axial groove 420 may extend at least partially in the longitudinal direction 217 from the bottommost end of the upper insert portion 402 to the uppermost end of the upper insert portion 402. It will be appreciated that multiple axial grooves may be defined on the outer insert surface 416. Each axial groove 420 may be evenly spaced about the outer insert surface 416.

The upper insert surface 418 may define an insert radial groove 422. The insert radial groove 422 may extend circumferentially about the central axis 215. It will be appreciated that multiple radial grooves may be defined on the upper insert surface 418.

The lower insert portion 404 defines a portion of the inner flow channel 410 and further includes a lower outer insert surface 424 and the lower insert surface 426. The lower outer insert surface 424 extends from the lower insert surface 426 to an uppermost end of the lower insert portion 404. The lower outer insert surface 424 may define multiple lower radial grooves 428 that extend circumferentially about central axis 215.

In an aspect of this disclosure, the fitting insert 400 may define an insert shoulder 430. The insert shoulder 430 may be located at the intersection of the upper insert portion 402 and the lower insert portion 404. The insert shoulder 430 may be formed by the upper insert portion 402 having a larger diameter than the diameter of the lower insert portion 404. The insert shoulder 430 may be configured to align with the outer fitting shoulder 346 of the outer fitting member 300 when the fitting insert 400 is positioned within the outer fitting member 400.

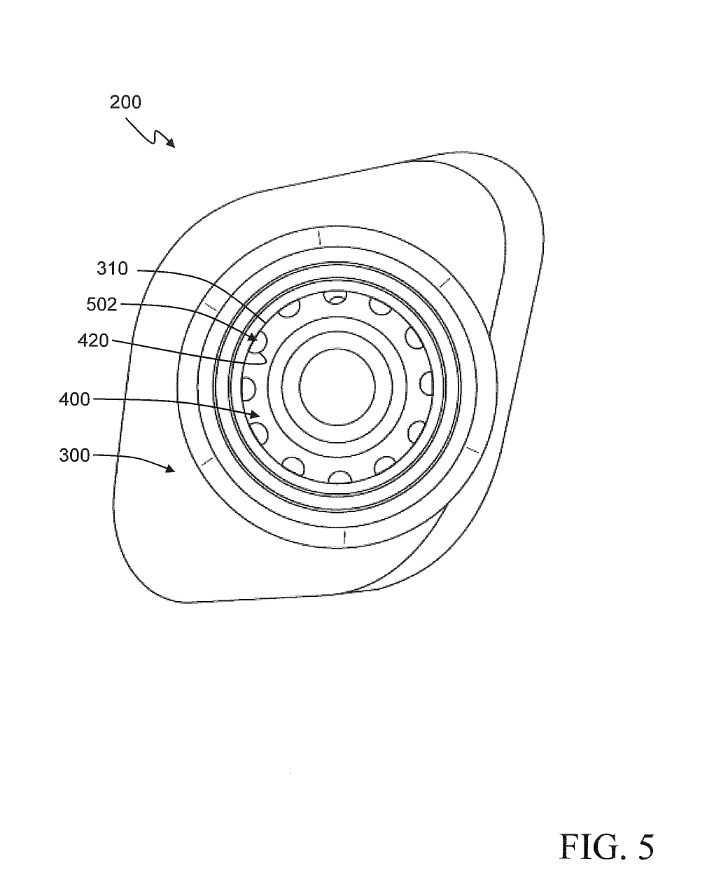

FIG. 5 illustrates a top view of the fitting assembly 200 with the fitting insert 400 positioned within the outer fitting member 300. The axial groove 420 formed by the outer insert surface 416 of the fitting insert 400 and the upper inner surface 310 of the fitting member 300 form a second leakage channel 502. The second leakage channel 502 may extend from the bottommost portion of the upper portion 202 of the fitting assembly 200 to the uppermost portion of the upper portion 202. The second leakage channel 502 may be in fluid communication with the first leakage channel 334, thereby forming a channel that extends through the fitting assembly 200. It will be appreciated that multiple second leakage channels 502 may be formed by multiple axial grooves 420 formed by the outer insert surface 416.

In an aspect of this disclosure, a total cross sectional area of the first leakage channel 334 may be substantially the same as a total cross sectional area of the second leakage channel 502. If there are multiple first leakage channels 334 and/or second leakage channels 502, the total cross sectional area of all the multiple first leakage channels 334 may be substantially the same as the total cross sectional area of all the multiple second leakage channels 502. Therefore, if there are fewer second leakage channels 502, the diameter of each second leakage channel 502 may be larger than the diameter of each individual first leakage channel 334. The sizing of each leakage channel 334, 502 may be determined based on fluid pressure, fluid density, diameter of the inner flow channel 410, or other similar factors that may affect a flow rate of a fluid through each leakage channel 334, 502.

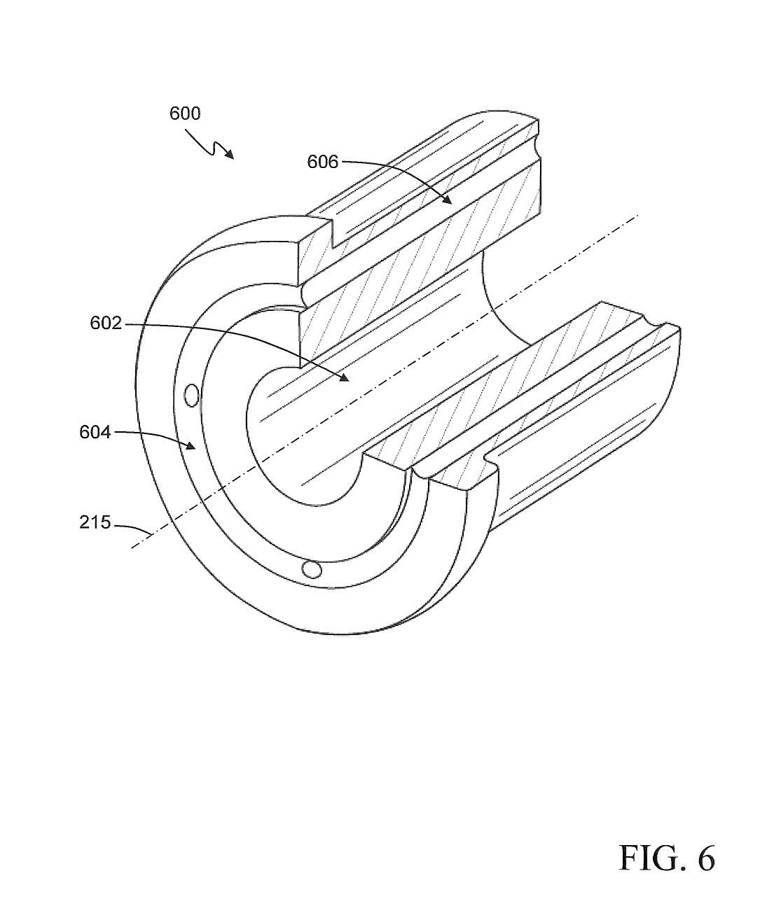

FIG. 6 illustrates a cross sectional view of a section of a dual-wall hose 600. The dual-wall hose 600 may include an inner hose channel 602, a radial hose channel 604, and an outer hose channel 606. The radial hose channel 604 may be in fluid communication with the outer hose channel 606. In an aspect of this disclosure, the dual-wall hose 600 may be configured to couple to an uppermost portion of the upper portion 202 of the fitting assembly 200 (as shown in FIG. 7). When the dual-wall hose 600 is coupled to the fitting assembly 200, the radial hose channel 604 may be in fluid communication with the second leakage channel 502 and the inner hose channel 602 may be in fluid communication with the inner flow channel 410.

Referring to FIG. 7, the dual-wall hose 600 may be attached to the fitting assembly 200 using a seal nut 702, or other means commonly used for connecting dual-wall hoses. A first inner o-ring 704 and a first outer o-ring 706 may be positioned between the dual-wall hose 600 and the fitting assembly 200 within the insert radial groove 422 and the first outer body radial groove 320, respectively. The first inner o-ring 704 may minimize fluid leakage from the inner flow channel 410 and/or the inner hose channel 602 to the second leakage channel 502 and/or the radial hose channel 604. The first outer o-ring 706 may minimize fluid leakage from the second leakage channel 502 and/or the radial hose channel 604 to the environment.

Continuing with FIG. 7, the fitting assembly 200 is shown coupled to the cylinder head 111. The fitting assembly 200 may be coupled by using bolts, welding, adhesives, or other coupling means known in the art. A second inner o-ring 708 and a second outer o-ring 710 may be positioned between the cylinder head 111 and the fitting assembly 200 within the first outer body radial groove 330 and the second outer body radial groove 332, respectively. The second inner o-ring 708 may minimize fluid leakage from the inner flow channel 410 to the first leakage channel 334 and the second outer o-ring 710 may minimize fluid leakage from the first leakage channel 334 to the environment.

In an aspect of this disclosure, the fitting assembly 200 may be substantially perpendicular or angularly offset at an angle of less than 90 degrees with respect to the surface 712 of the cylinder head 111. An angle Φ at which the central axis 215 is offset from the surface 712 may depend on the complexity, location, or size of the coupling between the fitting assembly 200 and the cylinder head 111, or for other reasons.

The fitting insert 400 may be constructed such that it may be slideably placed within and be in sliding contact with the outer fitting member 300. In an aspect of this disclosure, the fitting insert 400 may be lightly pressed into place. A length and diameter of the upper insert portion 402 may be substantially similar to a length and diameter of the upper body portion 302 of the outer fitting member 300, such that at least a portion of the upper outer insert surface 416 may be in contact with the upper inner surface 310. The contact between the upper outer insert surface 416 and the outer fitting member 300 may form the second leakage channel 502. Similarly, a length and diameter of the lower insert portion 404 may be substantially similar to a length and diameter of the lower body portion 304 of the outer fitting member 300.

The contact between the lower outer insert surface 424 surface and the lower inner surface 322 minimizes fluid leakage between the fitting insert 400 and the outer fitting member 300. Additionally, fitting insert o-rings 714 and 716 may be placed in the multiple lower radial grooves 428 to further minimize leakage between the fitting insert 400 and the outer fitting member 300. The fitting insert o-rings 714, 716 may also help secure the fitting insert 400 within the outer fitting member 300, such that motion between the fitting insert 400 and the outer fitting member 300 is minimized during operation.

A sensor or detection means 720 may be located along the first leakage channel 334, the second leakage channels 502, the radial hose channel 604 and/or the outer hose channel 606. The sensor may include a fluid sensor, pressure sensor, methane detector, or the like, capable of determining whether a fluid is present. For instance, a pressure sensor located along the second leakage channels 502 may detect a pressure change within channel, which may indicate the presence of a fluid.

### INDUSTRIAL APPLICABILITY

The present disclosure provides an advantageous apparatus and system for a dual-walled fitting 200. The dual-walled fitting 200 may be used for a variety of applications, including fluidly coupling a fuel conduit within an engine system. For example, in marine applications using gaseous fuel, such as natural gas, a dual-walled construction may be required for providing fuel to a cylinder. During operation, fuel may leak from a flow channel to the environment undetected. The first and second leakage channels 334, 502 may collect and prevent further leakage by permitting early detection of a fuel leak.

The dual-walled fitting 200 may be coupled directly to the cylinder head 111 or the intake manifold 118 of an engine. As fuel flows through the inner flow channel 410 and leaks into the leakage channels 334, 502, the sensor 720 may detect and indicate a fuel leak. The indication may be used to modify the operating conditions of the engine or to shut-down operations to assess the extent of the leak.

The dual-walled fitting 200 may include a minimal number of components, thereby simplifying the manufacturing process and promoting high volume manufacturing of the fitting 200. Additionally, the fitting 200 may be easily constructed. For example, the fitting insert 400 may be machined such that it may be lightly pressed into position within the outer fitting member 300.

The angle Φ at which the fitting 200 is offset from the cylinder head 111 or intake manifold 118 may be determined based on the location and/or surface to which the fitting 200 is to be coupled. This may allow for the fitting to be attached to various systems in addition to engine systems.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. A fitting assembly comprising:
an outer fitting member having an outer body, the outer body including:
an outer fitting surface,
a first inner surface defining a first channel,
a second inner surface defining a second channel, the second channel being aligned with the first channel in a longitudinal direction, the second channel extending from the outer fitting surface to the first channel, and the first channel extending from the second channel to the outer fitting surface, and
a third inner surface defining a first leakage channel, the first leakage channel extending to the outer fitting surface; and
a fitting insert having an upper body portion and a lower body portion, the upper body portion slideably disposed within the first channel and the lower body portion slideably disposed within the second channel, the upper body portion including:
an outer insert surface in sliding contact with the first inner surface, the outer insert surface defining multiple grooves, wherein multiple leakage channels are formed between the other insert surface and the first inner surface within the multiple grooves, and wherein the multiple leakage channels are in fluid communication with the first leakage channel, and wherein the multiple grooves are evenly spaced about the outer insert surface.

2. The fitting assembly of claim 1, wherein the lower body portion of the fitting insert and the upper body portion of the fitting insert are coaxial.

3. The fitting assembly of claim 1, wherein an inner insert surface of the fitting insert defines an inner flow channel, the inner insert surface extending circumferentially about the longitudinal direction.

4. The fitting assembly of claim 1, wherein a direction of the multiple leakage channels are angularly offset from the longitudinal direction.

5. (canceled)

6. The fitting assembly of claim 1, wherein the fitting insert is constructed of stainless steel.

7. The fitting assembly of claim 6, wherein the outer fitting member is constructed of a cast iron.

8. (canceled)

9. (canceled)

10. A fitting system for an engine, comprising:
a cylinder head;
an outer fitting member coupled to the cylinder head, the outer fitting member having an outer body, the outer body including:
an outer fitting surface,
a first inner surface defining a first channel,
a second inner surface defining a second channel, the second channel being aligned with the first channel in a longitudinal direction, the second channel extending from the outer fitting surface to the first channel, and the first channel extending from the second channel to the outer fitting surface, and
a third inner surface defining a first leakage channel, the first leakage channel extending to the outer fitting surface; and
a fitting insert having an upper body portion and a lower body portion, the upper body portion slideably disposed within the first channel and the lower body portion slideably disposed within the second channel, the upper body portion including:
an outer insert surface in sliding contact with the first inner surface, the outer insert surface defining multiple grooves, wherein multiple leakage channels are formed between the other insert surface and the first inner surface within the multiple grooves, and wherein the multiple leakage channels are in fluid communication with the first leakage channel, and wherein the multiple grooves are evenly spaced about the outer insert surface.

11. The fitting system of claim 10, wherein an inner insert surface of the fitting insert defines an inner flow channel, the inner insert surface extending circumferentially about the longitudinal direction.

12. (canceled)

13. (canceled)

14. (canceled)

15. (canceled)

16. (canceled)

17. The fitting system of claim 10, wherein the cylinder head includes a cylinder outer surface that extends in a first direction, wherein the outer fitting member is coupled to the outer surface, and wherein an angle between the longitudinal direction and the first direction is less than 90 degrees.

18. (canceled)

19. (canceled)

20. (canceled)
